(19) United States
(12) Patent Application Publication
(10) Pub. No.: US 2004/0085905 A1
(43) Pub. Date: May 6, 2004

(54) OAM packet data transmission method and ethernet passive optical network including control multiplexer for the same

(76) Inventors: Se-Youn Lim, Seoul (KR); Jae-Yeon Song, Seongnam-si (KR); Su-Hyung Kim, Seoul (KR); Min-Hyo Lee, Suwon-si (KR); Jin-Hee Kim, Suwon-si (KR); A-Jung Kim, Seoul (KR); Dae-Eop Kang, Seoul (KR)

Correspondence Address: CHA & REITER, LLC, 210 ROUTE 4 EAST STE 103, PARAMUS, NJ, 07652, US

(21) Appl. No.: 10/690,321

(22) Filed: Oct. 21, 2003

(30) Foreign Application Priority Data
Oct. 31, 2002 (KR) 2002-67037

(51) Int. Cl. H04J 1/16

(52) U.S. Cl. 370/236.2; 370/535

(57) ABSTRACT

A method for transmitting OAM (Operation, Administration and Maintenance) packet data by a control multiplexer of an OAM sublayer in an Ethernet passive optical network (EPON) accords priority to OAM packet data over MAC (Medium Access Control) client data awaiting transmission. The control multiplexer multiplexes the OAM packet data and the MAC client data according to the priority and transmits the multiplexed data to the MAC entity.

### CLAIM OF PRIORITY

This application claims priority under 35 U.S.C. § 119 to an application entitled “OAM Packet Data Transmission Method and Ethernet Passive Optical Network Including Control Multiplexer for the Same,” filed in the Korean Intellectual Property Office on Oct. 31, 2002 and assigned Serial No. 2002-67037, the contents of which are incorporated herein by reference.

### BACKGROUND OF THE INVENTION

1. Field of the Invention

The present invention relates generally to an Ethernet passive optical network (EPON), and in particular, to a method for transmitting operation, administration and maintenance (hereinafter referred to as “OAM”) information in an EPON.

2. Description of the Related Art

Standardization of medium access control (MAC) technology for Gigabit Ethernet and asynchronous transfer mode-passive optical network (ATM-PON) has already been completed, that standard appearing in IEEE 802.3z and ITU-T G983.1. In an ATM-PON which was first standardized, upstream and downstream transmissions are performed of frames created by grouping ATM cells of predetermined size. The ATM-PON has a tree-type structure by means of which an optical line termination (OLT) appropriately inserts downstream cells to be distributed to respective optical network units (ONUs) into the frame.

FIG. 1 is a block diagram illustrating a physical network structure of a general passive optical network. The network features one OLT 100 and one or more ONUs 110-1 to 110-3 each connected to the OLT 100. At least one end user (or network device) 120-1 to 120-3 is connected to each of the ONUs 110-1 to 110-3. Data 131-1 to 133-1 transmitted by the end users 120-1 to 120-3 is delivered to the OLT 100 via the ONUs 110-1 to 110-3.

In the EPON structure shown in FIG. 1 for transmitting an 802.3 Ethernet frame via a network with a point-to-multipoint (PTM) structure, and in accordance with a so-called ranging method of an optical distribution network (ODN) which is a passive element, data from the ONUs is multiplexed during upstream transmission to prevent data collision and is accessed by time division multiplexing (TDM), and the ONUs 110-1 to 110-3 receiving data broadcasted by the OLT 100 select only their own data from the received data.

To this end, upstream and downstream frames include a field for exchanging messages at stated periods, prepared in a private ATM cell or a general ATM cell. With the development of Internet technology, a subscriber side requires more bandwidth. End-to-end transmission will therefore likely be achieved with Gigabit Ethernet technology which provides relatively inexpensive equipment and can secure high bandwidth, rather than through ATM technology which provides relatively expensive equipment, has a bandwidth limitation and must segment an IP (Internet Protocol) packet. Therefore, even a PON structure requires Ethernet technology instead of ATM technology.

The IEEE 802.3ah Ethernet in the First Mile Task Force newly defines an OAM sublayer in an Ethernet system to be applied to First Mile, standardization of which is now under way. This standard gives higher priority to an OAM frame than to a data frame and minimizes the time required to generate and transmit the OAM frame, thereby making the OAM function more efficient. Specifically, in accordance with the IEE802.3ah EFM Draft v1.1, the OAM sublayer cuts off a path for transmitting MAC client data from an upper layer (i.e., MAC client), to alleviate difficulty that would otherwise consequently arise in delivering OAM PDUs (Packet Data Units) to a MAC control sublayer.

The cutting off of the MAC client data path, however, is operational only in a loop-back or unidirectional mode, so that, in a non-loop-back mode and a non-unidirectional mode, no priority is determined between OAM PDUs and MAC client data. For example, if there are many MAC client data frames at a time when OAM PDUs are generated, it is not possible to immediately transmit the generated OAM PDUs, preventing efficient transmission of OAM information.

### SUMMARY OF THE INVENTION

The present invention, in one aspect, provides an OAM packet data transmission method that, by immediately transmitting generated OAM PDUs, assures efficient network management, and an EPON including a control multiplexer for the same.

To achieve the above and other aspects, there is provided a method for transmitting OAM (Operation, Administration and Maintenance) packet data by a control multiplexer of an OAM sublayer in an Ethernet passive optical network (EPON), the OAM sublayer transmitting MAC (Medium Access Control) client data transmitted from a MAC client and OAM packet data made in an OAM controller to a MAC entity. In accordance with the method, if OAM packet data is generated by the OAM controller, higher priority is given to the OAM packet data rather than MAC client data that is waiting to be transmitted in the MAC client. The OAM packet data and the MAC client data are multiplexed according to the priority and transmitted to the MAC entity.

According to the present invention, a control multiplexer of an OAM sublayer for multiplexing MAC client data frames and OAM PDUs gives higher priority to the OAM PDUs than to the MAC client data frames. Therefore, if for some reason the transmission waiting queue for the MAC client data increases in length, the OAM PDUs are not subjected to transmission delay and consequent network management failure is avoided.

### BRIEF DESCRIPTION OF THE DRAWINGS

The above and other aspects, features and advantages of the present invention will become more apparent from the following detailed description when taken in conjunction with the accompanying drawings in which:

FIG. 1 is a block diagram illustrating a physical network structure of a general passive optical network;

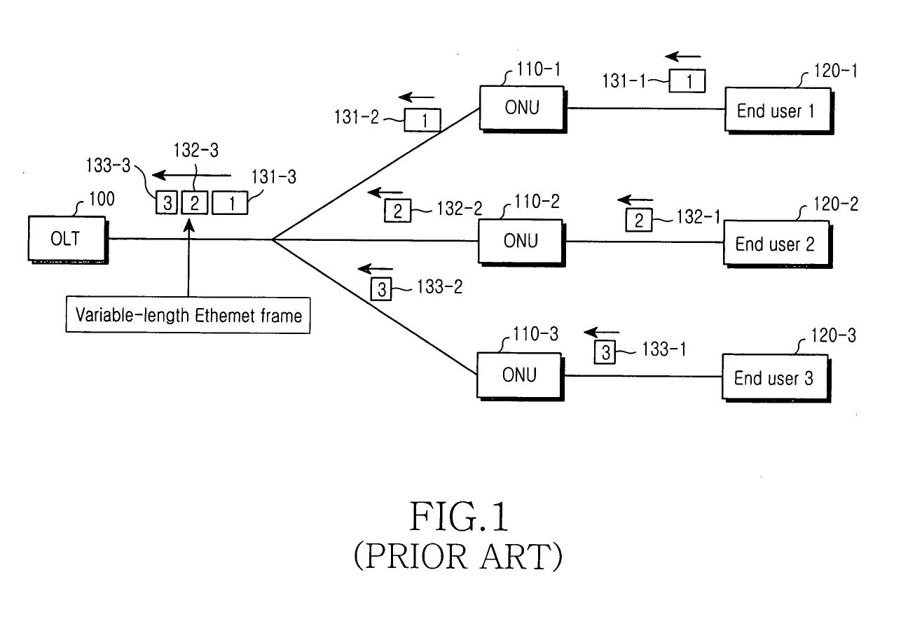

FIG. 2 is a block diagram illustrating an OAM sublayer defined in IEEE802.3ah EFM Draft v1.1;

FIG. 3 is a diagram for explaining an operation of a conventional control multiplexer;

FIG. 4 is a diagram for explaining an operation of a control multiplexer in which priority is given to OAM PDUs; and

FIG. 5 is a flowchart illustrating an operation of a control multiplexer according to an embodiment of the present invention.

### DETAILED DESCRIPTION OF THE PREFERRED EMBODIMENT

A preferred embodiment of the present invention will now be described in detail with reference to the annexed drawings. In the following description, a detailed description of known functions and configurations incorporated herein has been omitted for conciseness and clarity of presentation.

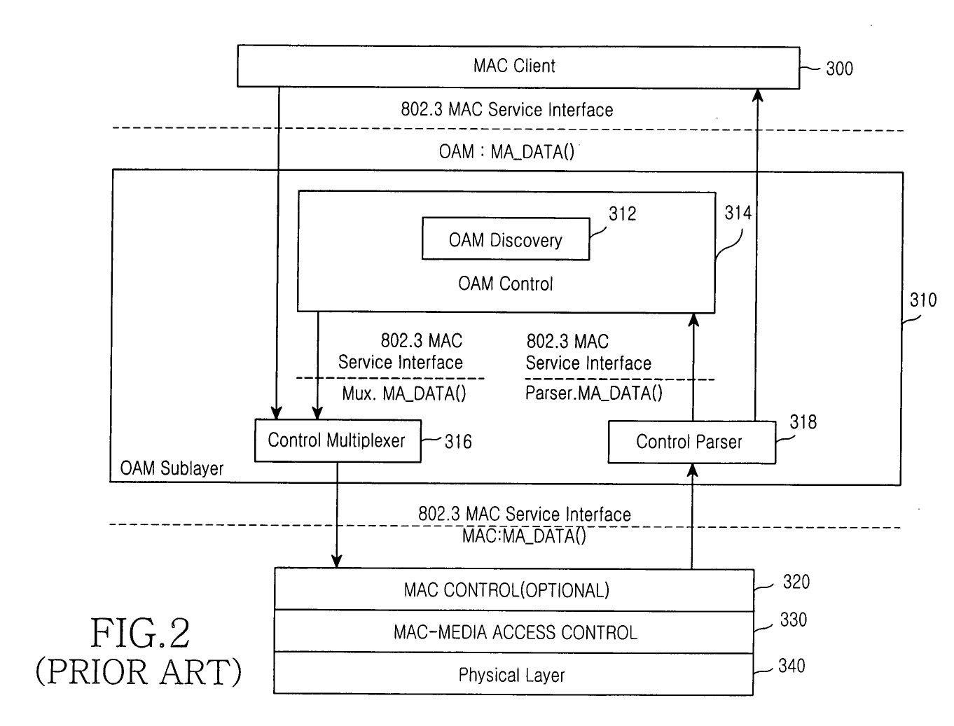

FIG. 2 is a block diagram illustrating an OAM sublayer 310 defined in IEEE802.3ah EFM Draft v1.1. The OAM sublayer is comprised of an OAM controller 314, a control multiplexer 316, and a control parser 318. MAC client data provided from an upper layer 300 and OAM PDUs created in the OAM controller 314 are multiplexed in the control multiplexer 316 for delivery to a MAC control sublayer 320.

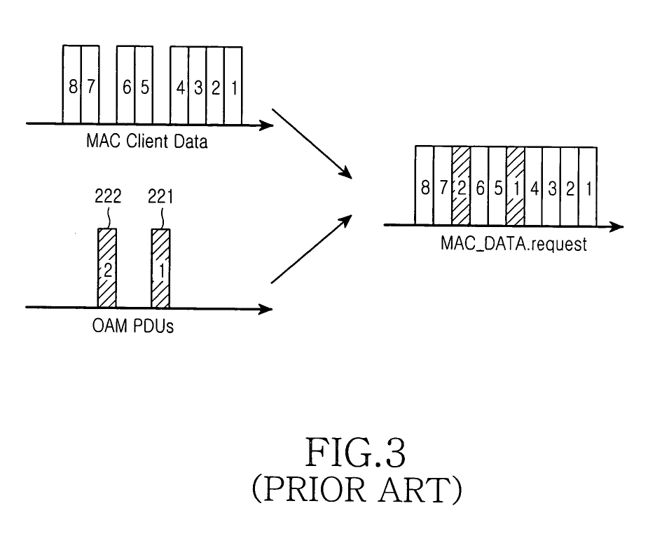

FIG. 3 is a diagram for explaining the operation of a conventional control multiplexer while transmitting OAM PDUs in an OAM operation in a non loop-back mode and a non-unidirectional mode. A conventional control multiplexer transmits MAC client data and OAM PDUs in order of generation. As illustrated in FIG. 3, if MAC client data frames are waiting to be transmitted, OAM PDUs generated cannot be immediately transmitted to the MAC control sublayer 320. That is, if OAM PDUs are generated later than the MAC client data frames which have not yet transmitted to the MAC control sublayer 320, the OAM PDUs are not transmitted until those earlier-generated MAC client data frames are transmitted completely. Therefore, as transmission waiting queue size for the MAC client data frames increases, so does waiting time of the OAM PDUs.

If MAC client data frames generated earlier than OAM PDUs are waiting to be transmitted, since the OAM PDUs cannot be transmitted, the transmission waiting queue size for the MAC client data frames proportionately increases the transmission waiting time of the OAM PDUs. The resultant transmission delay of OAM data makes it difficult if not impossible for the OAM function to rapidly cope with impending network management failure should such a contingency arise.

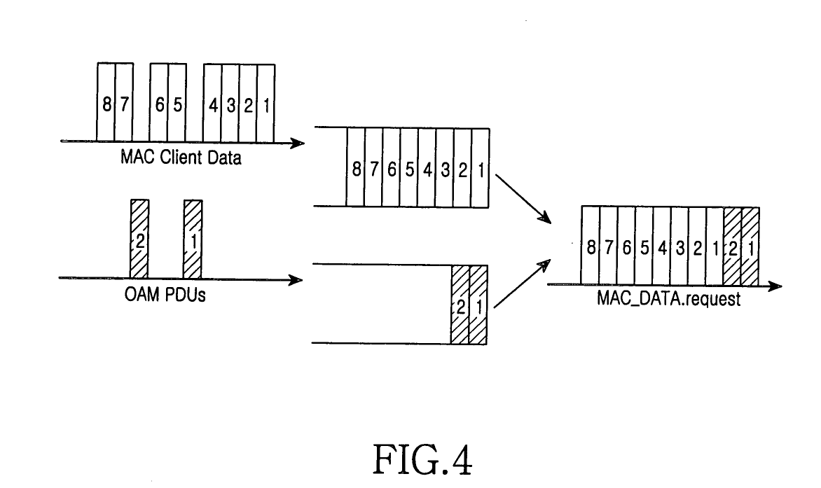

FIG. 4 is a diagram for explaining the operation of a control multiplexer that accords priority OAM PDUs. A control multiplexer according to the present invention gives priority to generated OAM PDUs to preferentially transmit the OAM PDUs ahead of MAC client data frames, in order to solve the problem occurring when MAC client data frames and OAM PDUs are transmitted in order of generation.

As described in conjunction with FIG. 3, if MAC client data frames are generated in order of 1, 2, 3, 4, . . . , and OAM PDUs are generated in order or 1 and 2 with priority not being given (see FIG. 3), then the OAM PDUs are not transmitted until MAC client data frames generated earlier than the OAM PDUs are transmitted in order of generation, as described in conjunction with FIG. 3.

However, the control multiplexer 316 in the OAM sublayer according to the invention gives to the OAM PDUs priority higher than that accorded to the MAC client data frames. The control multiplexer 316, in effect, first transmits OAM PDUs even if they are generated later than the MAC client frames. As illustrated in FIG. 4, since OAM PDUs are higher in priority than MAC client data frames, the OAM PDUs are transmitted in advance of the MAC client data frames regardless of their generation order. Accordingly, the OAM PDUs are not subject to transmission delay caused by an increase in length of a transmission waiting queue for the MAC client data frames.

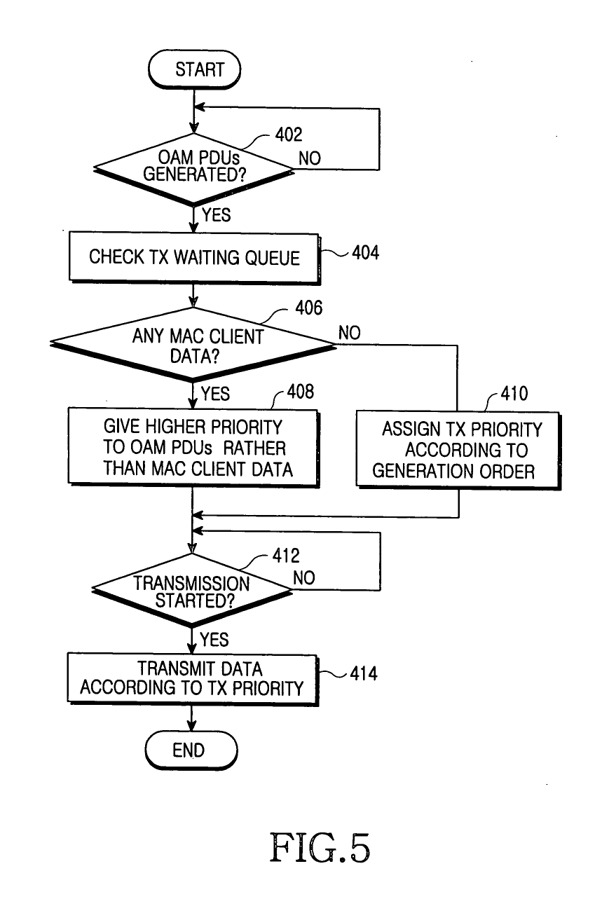

FIG. 5 is a flowchart illustrating, by way of non-limitative example, operation of a control multiplexer according to an embodiment of the present invention. Referring to FIGS. 2 and 5, the control multiplexer 316 of the OAM sublayer determines in step 402 whether the OAM controller 314 has generated OAM PDUs. If OAM PDUs have been generated, the OAM controller 314 delivers them to the control multiplexer 316 which transmits the OAM PDUs to the MAC control sublayer 320. Thus, the control multiplexer 316 can determine whether the OAM controller 314 has generated OAM PDUs. If OAM PDUs have been generated, the control multiplexer 316 checks a transmission waiting queue for MAC client data frames in step 404. Thereafter, the control multiplexer 316 monitors in step 406 whether the transmission waiting queue for the MAC client data frames has MAC client data to be delivered to the MAC control sublayer 320. If the transmission waiting queue for the MAC client data frames has MAC client data to be delivered to the MAC control sublayer 320, the control multiplexer 316 gives higher priority to OAM PDUs than to the MAC client data frames in step 408, and then proceeds to step 412. However, if it is determined that there is no MAC client data to transmit, the control multiplexer 316 assigns transmission priority according to generation order in step 410.

Thereafter, the control multiplexer 316 determines in step 412 whether transmission to the MAC control sublayer 320 is started. If transmission to the MAC control sublayer 320 is initiated, the control multiplexer 316 multiplexes OAM PDUs and MAC client data frames according to priorities assigned thereto, and then transmits the multiplexed data to the MAC control sublayer 320 in step 414.

As can be appreciated from the foregoing description, the control multiplexer of the OAM sublayer for multiplexing MAC client data frames and OAM PDUs, gives higher priority to the OAM PDUs than to the MAC client data frames. This priority scheme prevents transmission delay of OAM PDUs from occurring in response to an increase in length of the transmission waiting queue for MAC client data frames. The resultant efficient transmission of OAM information assures the availability of OAM to prevent impending network management failure in the event of such a contingency.

While the invention has been shown and described with reference to a particular preferred embodiment thereof, it will be understood by those skilled in the art that various changes in form and details may be made therein. For example, the innovatively configured OAM sublayer and its components may be implemented in software, hardware or firmware. Various modifications may be made without departing from the spirit and scope of the invention as defined by the appended claims.

What is claimed is:

1. A method for transmitting OAM (Operation, Administration and Maintenance) packet data by a control multiplexer of an OAM sublayer in an Ethernet passive optical network (EPON), the OAM sublayer transmitting to a MAC (Medium Access Control) entity MAC client data transmitted from a MAC client and OAM packet data created in an OAM controller, the method comprising the steps of:
if OAM packet data is generated by the OAM controller, giving to the OAM packet data priority higher than that given to MAC client data that is in the MAC client and that is waiting to be transmitted; and
multiplexing the OAM packet data and the MAC client data according to the priority and transmitting the multiplexed data to the MAC entity.

2. The method of claim 1, wherein the priority giving step comprises the step of determining whether OAM packet data is generated by the OAM controller.

3. The method of claim 2, wherein the determining step is performed by a control multiplexer.

4 The method of claim 3, wherein the multiplexing step is performed by the control multiplexer.

5. The method of claim 2, wherein the determining step comprises the step of determining whether there presently exists in a queue said MAC client data that is in the MAC client and that is waiting to be transmitted.

6. The method of claim 5, wherein the determining step is performed by a control multiplexer.

7. The method of claim 6, wherein the multiplexing step is performed by the control multiplexer.

8. The method of claim 7, wherein if the MAC client data is determined to not exist in said queue, the multiplexing step comprises the step of assigning priority to the data according to an order in which the data was generated.

9. The method of claim 5, wherein if the MAC client data is determined to not exist in said queue, the multiplexing step comprises the step of assigning priority to the data according to an order in which the data was generated.

10. An OAM (Operation, Administration and Maintenance) sublayer of an Ethernet passive optical network (EPON), the OAM sublayer being configured for transmitting to a MAC (Medium Access Control) entity MAC client data transmitted from a MAC client and OAM packet data created in an OAM controller, the OAM sublayer comprising a control multiplexer for giving, if OAM packet data is generated by the OAM controller, priority higher than that given to MAC client data that is in the MAC client and that is waiting to be transmitted, and transmitting the OAM packet data to the MAC entity in advance of the MAC client data.

11. The OAM sublayer of claim 10, wherein the control multiplexer is configured for determining whether OAM packet data is generated by the OAM controller.

12. The OAM sublayer of claim 10, wherein the control multiplexer is configured to multiplex MAC client data and OAM packet data.

13. The OAM sublayer of claim 11, wherein the control multiplexer is configured for determining whether there presently exists in a queue said MAC client data that is in the MAC client and that is waiting to be transmitted.

14. The OAM sublayer of claim 13, wherein the control multiplexer is configured to, if the MAC client data is determined to not exist in said queue, assign priority to the data according to an order in which the data was generated.

15. A computer program product having a computer-readable medium containing a computer program executable on a processor, said computer program comprising the OAM sublayer of claim 10, wherein the control multiplexer is implemented as instructions of said computer program that multiplex the OAM packet data and the MAC client data in accordance with said priority.

16. The computer program product of claim 15, wherein the control multiplexer is configured for determining whether OAM packet data is generated by the OAM controller.

17. The computer program product of claim 16, wherein the control multiplexer is configured to multiplex MAC client data and OAM packet data.

18. The computer program product of claim 17, wherein the control multiplexer is configured for determining whether there presently exists in a queue said MAC client data that is in the MAC client and that is waiting to be transmitted.

19. The computer program product of claim 16, wherein the control multiplexer is configured for determining whether there presently exists in a queue said MAC client data that is in the MAC client and that is waiting to be transmitted.

20. The computer program product of claim 15, wherein the control multiplexer is configured for determining whether there presently exists in a queue said MAC client data that is in the MAC client and that is waiting to be transmitted.
